(19) United States
(12) Patent Application Publication
(10) Pub. No.: US 2017/0230988 A1
(43) Pub. Date: Aug. 10, 2017

(54) METHODS AND APPARATUS FOR COMMUNICATION MODE CONFIGURATION IN A HIGH-EFFICIENCY WIRELESS NETWORK

(71) Applicant: QUALCOMM Incorporated, San Diego, CA (US)

(72) Inventors: Yan Zhou, San Diego, CA (US); Alfred Asterjadhi, San Diego, CA (US); Gwendolyn Denise Barriac, Encinitas, CA (US); Simone Merlin, San Diego, CA (US); George Cherian, San Diego, CA (US)

(21) Appl. No.: 15/425,897

(22) Filed: Feb. 6, 2017

Related U.S. Application Data
(60) Provisional application No. 62/292,609, filed on Feb. 8, 2016.

(51) Int. Cl. H04W 72/12; H04W 72/04

(52) U.S. Cl. CPC H04W 72/121; H04W 72/0406

(57) ABSTRACT

Methods and apparatuses for configuring communication modes in wireless networks are provided. In some aspects, an apparatus configured for wireless communication is provided. The apparatus includes a processing system configured to select one of a first state, a second state, and a third state. In the first state, communication with a wireless node is permitted in either one a first mode in which the communication can be based on carrier contention or a second mode in which the communication can be based on scheduling information. In the second state, the communication with the wireless node is permitted only in the first mode. In the third state, communication with the wireless node is permitted only in the second mode. The apparatus further includes a communication interface configured to communicate with the wireless node according to the first and second modes.

### PRIORITY CLAIM

This application claims priority under 35 U.S.C. §119(e) to U.S. Provisional App. No. 62/292,609, filed Feb. 8, 2016, which is incorporated by reference herein in its entirety.

### FIELD

The present application relates generally to wireless communications, and more specifically to methods and apparatuses for configuring communication modes in high-efficiency wireless networks.

### BACKGROUND

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN).

As wireless communications continue to advance, communication schemes continue to grow more complicated, there may be a need to more efficiently transmit messages and frames across various communication schemes.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include improved communications between access points and stations in a wireless network.

Some implementations provide an apparatus configured for wireless communication. The apparatus includes at least one antenna and a processing system configured to select one of a first state, a second state, and a third state. In the first state, communication with a wireless node is permitted in either one a first mode in which the communication can be based on carrier contention or a second mode in which the communication can be based on scheduling information. In the second state, the communication with the wireless node is permitted only in the first mode. In the third state, communication with the wireless node is permitted only in the second mode. The apparatus further includes a communication interface configured to communicate, via the at least one antenna, with the wireless node according to the first and second modes.

In some aspects, the processing system can be further configured to receive the scheduling information in a trigger frame prior to the communication. In some aspects, the processing system can be further configured to select one of the first, second, or third state based on one or more metrics. In some aspects, the one or more metrics can include any combination of: a link budget, a signal strength received from the wireless node, a contention or collision metric, and a packet latency requirement.

In some aspects, the request can be carried in any combination of: a mode configuration high-efficiency (HE) control field, a receiver operation mode indicator (ROMI) HE control field, a quality-of-service (QoS) control field, a control frame, a management frame, an action frame, a beacon, or a physical layer (PHY) header. In some aspects, the processing system can be further configured to generate a configuration request requesting entry into any of the first, second, or third state. The communication interface can be further configured to provide the configuration request for transmission to the wireless node. In some aspects, the configuration request can be carried in any combination of: a mode configuration high-efficiency (HE) control field, a receiver operation mode indicator (ROMI) HE control field, a quality-of-service (QoS) control field, a control frame, a management frame, an action frame, a beacon, or a physical layer (PHY) header.

In some aspects, the configuration request can indicate that the first, second, or third state applies only to communications meeting one or more conditions specified in the configuration request. In some aspects, the one or more conditions specified in the configuration request include any combination of: certain data traffic types, certain frame types or subtypes, certain stations or station types, certain information types, uplink (UL) communications, downlink (DL) communications, both UL and DL communications, certain communications resources including scheduled time windows, bandwidths, transmit opportunities (TXOPs), or service periods. In some aspects, the configuration request can specify one or more allowed multi-user (MU) communication types if the third state is selected.

In some aspects, the configuration request can specify one or more selected modes, one or more corresponding conditions, and one or more allowed multi-user (MU) communication types. In some aspects, the processing system can be further configured to generate unilateral configuration message announcing entry into any of the first, second, or third state. The communication interface can be configured to output the unilateral configuration message for transmission to the wireless node. The communication interface can be configured to receive an acknowledgment message acknowledging receipt of the unilateral configuration message.

In some aspects, the processing system can be further configured to generate a trigger frame instructing the wireless node to enter the first state, and the communication interface can be configured to output the trigger frame for transmission to the wireless node. In some aspects, the trigger frame includes scheduling information for the wireless communication.

In some aspects, the processing system can be further configured to exclude the wireless node in any communications under the second mode, wherein the communication is in the first mode. In some aspects, the processing system can be further configured to schedule any combination of more resources, communications priority, or acceptance of requests, for wireless nodes that select the third state for reciprocal communication with the apparatus. The communication interface can be further configured to communicate with the wireless node based on the schedule. In some aspects, the processing system can be further configured to generate an advertisement message advertising a degree to which the apparatus favors the wireless nodes that select the third state for reciprocal communication with the apparatus. The communication interface can be configured to output the advertisement message for transmission to the wireless node.

Some implementations provide a method for wireless communication. The method includes selecting, at an apparatus, one of a first state, a second state, and a third state. In the first state, communication with a wireless node is permitted in either one a first mode in which the communication can be based on carrier contention or a second mode in which the communication can be based on scheduling information. In the second state, the communication with the wireless node is permitted only in the first mode. In the third state, communication with the wireless node is permitted only in the second mode. The method further includes communicating with the wireless node according to the first and second modes.

In some aspects, the method can further include receiving the scheduling information in a trigger frame prior to the communication. In some aspects, the method can further include selecting one of the first, second or third state based on one or more metrics. In some aspects, the one or more metrics can include any combination of: a link budget, a signal strength received from the wireless node, a contention or collision metric, and a packet latency requirement.

In some aspects, the request can be carried in any combination of: a mode configuration high-efficiency (HE) control field, a receiver operation mode indicator (ROMI) HE control field, a quality-of-service (QoS) control field, a control frame, a management frame, an action frame, a beacon, or a physical layer (PHY) header. In some aspects, the method can further include preparing for transmission, to the wireless node, a configuration request requesting entry into any of the first, second, or third state; and receiving, from the wireless node, a configuration response approving, rejecting, or revising the configuration request. In some aspects, the configuration request can be carried in any combination of: a mode configuration high-efficiency (HE) control field, a receiver operation mode indicator (ROMI) HE control field, a quality-of-service (QoS) control field, a control frame, a management frame, an action frame, a beacon, or a physical layer (PHY) header.

In some aspects, the configuration request can indicate that the first, second, or third state applies only to communications meeting one or more conditions specified in the configuration request. In some aspects, the one or more conditions specified in the configuration request include any combination of: certain data traffic types, certain frame types or subtypes, certain stations or station types, certain information types, uplink (UL) communications, downlink (DL) communications, both UL and DL communications, certain communications resources including scheduled time windows, bandwidths, transmit opportunities (TXOPs), or service periods. In some aspects, the configuration request can specify one or more allowed multi-user (MU) communication types if the third state is selected.

In some aspects, the configuration request can specify one or more selected modes, one or more corresponding conditions, and one or more allowed multi-user (MU) communication types. In some aspects, the method can further include generating a unilateral configuration message announcing entry into any of the first, second, or third state.

In some aspects, the method can further include generating a trigger frame instructing the wireless node to enter the first state, and outputting the trigger frame for transmission to the wireless node. In some aspects, the trigger frame includes scheduling information for the wireless communication.

In some aspects, the method can further include excluding the wireless node in any transmissions under the second mode, wherein the communication is in the first mode. In some aspects, the method can further include scheduling any combination of more resources, communications priority, or acceptance of requests, for wireless nodes that select the third state for reciprocal communication with the apparatus, and communicating with the wireless node based on the schedule. In some aspects, the method can further include generating an advertisement message advertising a degree to which the apparatus favors the wireless nodes that select the third state for reciprocal communication with the apparatus, and outputting the advertisement message for transmission to the wireless node.

Some implementations provide a computer readable medium encoded thereon with instructions that when executed cause an apparatus to perform a method of wireless communication. The method includes selecting one of a first state, a second state, and a third state. In the first state, communication with a wireless node can be permitted in either one a first mode in which the communication can be based on carrier contention or a second mode in which the communication can be based on scheduling information. In the second state, the communication with the wireless node can be permitted only in the first mode. In the third state, communication with the wireless node can be permitted only in the second mode. The method further includes communicating with the wireless node according to the first and second modes.

In some aspects, the method can further include receiving the scheduling information in a trigger frame prior to the communication. In some aspects, the instructions when executed further cause the apparatus to select one of the first, second, or third state based on one or more metrics. In some aspects, the one or more metrics can include any combination of: a link budget, a signal strength received from the wireless node, a contention or collision metric, and a packet latency requirement.

In some aspects, the request can be carried in any combination of: a mode configuration high-efficiency (HE) control field, a receiver operation mode indicator (ROMI) HE control field, a quality-of-service (QoS) control field, a control frame, a management frame, an action frame, a beacon, or a physical layer (PHY) header. In some aspects, the instructions when executed further cause the apparatus to generate a configuration request requesting entry into any of the first, second, or third state, and output the configuration request for transmission to the wireless node. In some aspects, the configuration request can be carried in any combination of: a mode configuration high-efficiency (HE) control field, a receiver operation mode indicator (ROMI) HE control field, a quality-of-service (QoS) control field, a control frame, a management frame, an action frame, a beacon, or a physical layer (PHY) header.

In some aspects, the configuration request can indicate that the first, second, or third state applies only to communications meeting one or more conditions specified in the configuration request. In some aspects, the one or more conditions specified in the configuration request include any combination of: certain data traffic types, certain frame types or subtypes, certain stations or station types, certain information types, uplink (UL) communications, downlink (DL) communications, both UL and DL communications, certain communications resources including scheduled time windows, bandwidths, transmit opportunities (TXOPs), or service periods. In some aspects, the configuration request can specify one or more allowed multi-user (MU) communication types if the third state is selected.

In some aspects, the configuration request can specify one or more selected modes, one or more corresponding conditions, and one or more allowed multi-user (MU) communication types. In some aspects, the instructions when executed further cause the apparatus to generate a unilateral configuration message announcing entry into any of the first, second, or third state, and to output the unilateral configuration message for transmission to the wireless node. In some aspects, the instructions when executed further cause the apparatus to receive an acknowledgment message acknowledging receipt of the unilateral configuration message.

In some aspects, the instructions when executed further cause the apparatus to generate a trigger frame instructing the wireless node to enter the first state, and to output the trigger frame for transmission to the wireless node. In some aspects, the trigger frame includes scheduling information for the wireless communication.

In some aspects, the instructions when executed further cause the apparatus to exclude the wireless node in any communications under the second mode, wherein the communication is in the first mode. In some aspects, the instructions when executed further cause the apparatus to schedule any combination of more resources, communications priority, or acceptance of requests, for wireless nodes that select the third state for reciprocal communication with the apparatus, and to communicate with the wireless node based on the schedule. In some aspects, the instructions when executed further cause the apparatus to generate an advertisement message advertising a degree to which the apparatus favors the wireless nodes that select the third state for reciprocal communication with the apparatus, and to output the advertisement message for transmission to the wireless node.

Some implementations provide another apparatus for wireless communication. The apparatus includes means for selecting one of a first state, a second state, and a third state. In the first state, communication with a wireless node is permitted in either one a first mode in which the communication can be based on carrier contention or a second mode in which the communication can be based on scheduling information. In the second state, the communication with the wireless node is permitted only in the first mode. In the third state, communication with the wireless node is permitted only in the second mode. The apparatus further includes means for communicating with the wireless node according to the first and second modes.

In some aspects, the apparatus can further include means for receiving the scheduling information in a trigger frame prior to the communication. In some aspects, the apparatus can further include means for selecting one of the first, second or third state based on one or more metrics. In some aspects, the one or more metrics can include any combination of: a link budget, a signal strength received from the wireless node, a contention or collision metric, and a packet latency requirement.

In some aspects, the request can be carried in any combination of: a mode configuration high-efficiency (HE) control field, a receiver operation mode indicator (ROMI) HE control field, a quality-of-service (QoS) control field, a control frame, a management frame, an action frame, a beacon, or a physical layer (PHY) header. In some aspects, the apparatus can further include preparing for transmission, to the wireless node, a configuration request requesting entry into any of the first, second, or third state; and receiving, from the wireless node, a configuration response approving, rejecting, or revising the configuration request. In some aspects, the configuration request can be carried in any combination of: a mode configuration high-efficiency (HE) control field, a receiver operation mode indicator (ROMI) HE control field, a quality-of-service (QoS) control field, a control frame, a management frame, an action frame, a beacon, or a physical layer (PHY) header.

In some aspects, the configuration request can indicate that the first, second, or third state applies only to communications meeting one or more conditions specified in the configuration request. In some aspects, the one or more conditions specified in the configuration request include any combination of: certain data traffic types, certain frame types or subtypes, certain stations or station types, certain information types, uplink (UL) communications, downlink (DL) communications, both UL and DL communications, certain communications resources including scheduled time windows, bandwidths, transmit opportunities (TXOPs), or service periods. In some aspects, the configuration request can specify one or more allowed multi-user (MU) communication types if the third state is selected.

In some aspects, the configuration request can specify one or more selected modes, one or more corresponding conditions, and one or more allowed multi-user (MU) communication types. In some aspects, the apparatus can further include means for generating a unilateral configuration message announcing entry into any of the first, second, or third state, and means for outputting the unilateral configuration message for transmission to the wireless node.

In some aspects, the apparatus can further include means for generating a trigger frame instructing the wireless node to enter the first state and means for outputting the trigger frame for transmission to the wireless node. In some aspects, the trigger frame includes scheduling information for the wireless communication.

In some aspects, the apparatus can further include means for excluding the wireless node in any transmissions under the second mode, wherein the communication is in the first mode. In some aspects, the apparatus can further include means for scheduling any combination of more resources, communications priority, or acceptance of requests, for wireless nodes that select the third state for reciprocal communication with the apparatus; and means for communicating with the wireless node based on the schedule. In some aspects, the apparatus can further include means for generating an advertisement message advertising a degree to which the apparatus favors the wireless nodes that select the third state for reciprocal communication with the apparatus, and means for outputting the advertisement message for transmission to the wireless node.

Some implementations provide a wireless node for wireless communication. The wireless node includes a processing system configured to select one of a first state, a second state, and a third state. In the first state, communication with a second wireless node is permitted in either one a first mode in which the communication can be based on carrier contention or a second mode in which the communication can be based on scheduling information. In the second state, the communication with the second wireless node is permitted only in the first mode. In the third state, communication with the second wireless node is permitted only in the second mode. The wireless node further includes a communication interface configured to communicate with the second wireless node according to the first and second modes. The wireless node further includes a transmitter configured to transmit at least one message from the communication interface to the second wireless node.

### BRIEF DESCRIPTION OF THE DRAWINGS

FIG. 1 illustrates an example of a wireless communication system in which aspects of the present disclosure may be employed.

FIG. 2 illustrates various components that may be utilized in a wireless device that may be employed within the wireless communication system of FIG. 1.

FIG. 3 illustrates an example configuration sequence in wireless communication system of FIG. 1.

FIG. 4 shows a flow chart of an exemplary method of wireless communication in a wireless communication system.

FIG. 5 is a diagram illustrating an exemplary embodiment of a frame including a configuration request.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Wireless network technologies may include various types of wireless local area networks (WLANs). A WLAN may be used to interconnect nearby devices together, employing widely used networking protocols. The various aspects described herein may apply to any communication standard, such as WiFi or, more generally, any member of the IEEE 802.11 family of wireless protocols. For example, the various aspects described herein may be used as part of the IEEE 802.11ah protocol, which uses sub-1 GHz bands.

In some aspects, wireless signals in a sub-gigahertz band may be transmitted according to the 802.11ah protocol using orthogonal frequency-division multiplexing (OFDM), direct-sequence spread spectrum (DSSS) communications, a combination of OFDM and DSSS communications, or other schemes. Implementations of the 802.11ah protocol may be used for sensors, metering, and smart grid networks. Advantageously, aspects of certain devices implementing the 802.11ah protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be three types of devices: access points (“APs”), relays, and clients (also referred to as stations, or “STAs”). In general, an AP serves as a hub or base station for the WLAN, a relay device provides a communication link between the AP for the WLAN and one or more STAs, which serve as users of the WLAN. For example, an STA may be a laptop computer, a personal digital assistant (PDA), a mobile phone, etc. In an example, an STA connects to an AP, through a relay device, via WiFi (e.g., IEEE 802.11 protocol such as 802.11ah) compliant wireless links to obtain general connectivity to the Internet or to other wide area networks. In some implementations, an STA may also be used as a relay device.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or Smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

A wireless node may comprise an access terminal (“AT”) or STA, an AP or a relay-capable wireless device having any combination of a STA or AP operation, i.e., a wireless node may have AT or STA operation, AP operation, or both AT/STA and AP operations.

As discussed above, certain of the devices described herein may implement the 802.11ah standard, for example. Such devices, whether used as an STA, a relay device, an AP, or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g., for use with hotspots), or to implement machine-to-machine communications.

Mode configuration requests can be used to select between a plurality of states in which communication with a wireless device is permitted in various modes.

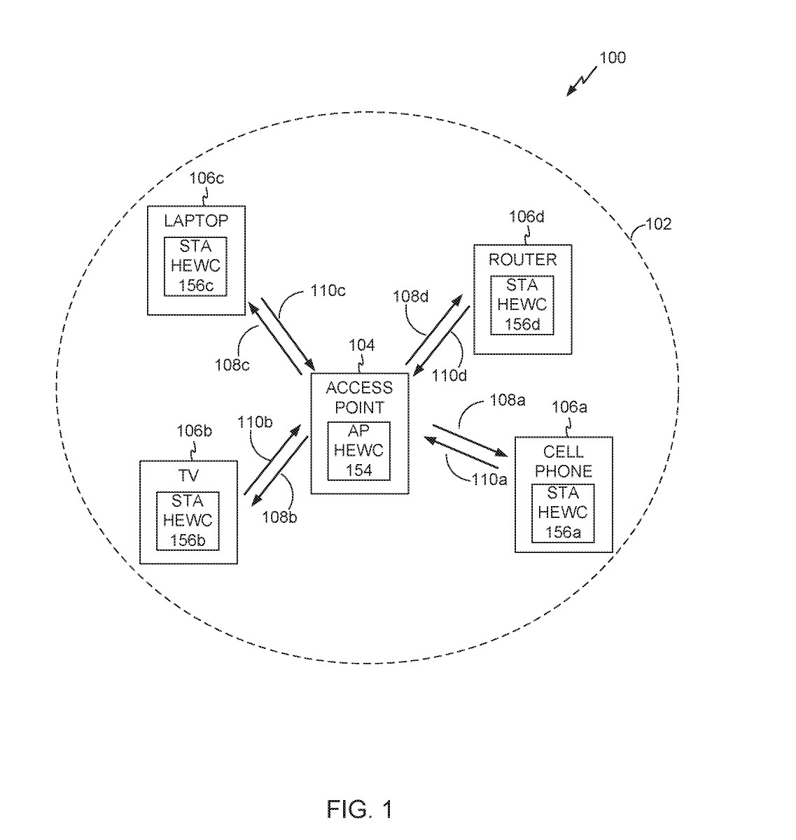

FIG. 1 shows an exemplary wireless communication system 100 in which aspects of the present disclosure can be employed. The wireless communication system 100 may operate pursuant to a wireless standard, for example a high-efficiency 802.11 standard. The wireless communication system 100 may include an AP 104, which communicates with STAs 106A-106D.

A communication link that facilitates transmission from the AP 104 to one or more of the STAs 106 can be referred to as a downlink (DL) 108, and a communication link that facilitates transmission from one or more of the STAs 106A-106D to the AP 104 can be referred to as an uplink (UL) 110. Alternatively, a downlink 108 can be referred to as a forward link or a forward channel, and an uplink 110 can be referred to as a reverse link or a reverse channel.

The AP 104 may act as a base station and provide wireless communication coverage in a basic service area (BSA) 102. The AP 104 along with the STAs 106A-106D associated with the AP 104 and that use the AP 104 for communication can be referred to as a basic service set (BSS). It should be noted that the wireless communication system 100 may not have a central AP 104, but rather may function as a peer-to-peer network between the STAs 106A-106D. Accordingly, the functions of the AP 104 described herein may alternatively be performed by one or more of the STAs 106A-106D.

In some aspects, a STA 106 can be required to associate with the AP 104 in order to send communications to and/or receive communications from the AP 104. In one aspect, information for associating is included in a broadcast by the AP 104. To receive such a broadcast, the STA 106 may, for example, perform a broad coverage search over a coverage region. A search may also be performed by the STA 106 by sweeping a coverage region in a lighthouse fashion, for example. After receiving the information for associating, the STA 106 may transmit a reference signal, such as an association probe or request, to the AP 104. In some aspects, the AP 104 may use backhaul services, for example, to communicate with a larger network, such as the Internet or a public switched telephone network (PSTN).

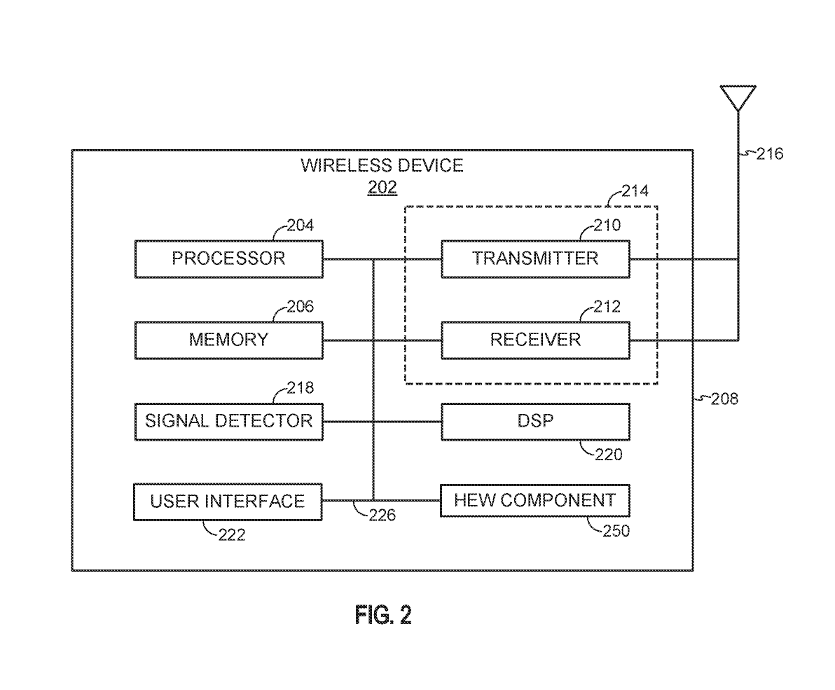

In an aspect, the AP 104 includes an AP high-efficiency wireless component (HEWC) 154. The AP HEWC 154 may perform some or all of the operations described herein to enable communications between the AP 104 and the STAs 106A-106D using the high-efficiency 802.11 protocol. The functionality of some implementations of the AP HEWC 154 is described in greater detail below with respect to FIGS. 2B, 3, and 4.

Alternatively, or in addition, the STAs 106A-106D may include a STA HEWC 156. The STA HEWC 156 may perform some or all of the operations described herein to enable communications between the STAs 106A-106D and the AP 104 using the high-efficiency 802.11 protocol.

A variety of processes and methods can be used for transmissions in the wireless communication system 100 between the AP 104 and the STAs 106A-106D. For example, signals can be sent and received between the AP 104 and the STAs 106A-106D in accordance with single-user (SU) modes in which only a single device is permitted to transmit at a time. Generally, wireless networks that use a regular 802.11 protocol (for example, 802.11ax, 802.11ah, 802.11ac, 802.11a, 802.11b, 802.11g, 802.11n, etc.) operate according to as carrier sense multiple access (CSMA) mechanism for SU medium access. In various aspects, SU transmissions by the AP 104 and the STAs 106A-106D can be initiated when no traffic is sensed on the medium, or at a random or pseudorandom backoff time after sensing traffic on the wireless medium. Here, SU mode generally refers to contention based transmissions, e.g., based on CSMA.

Additionally, or alternatively, signals can be sent and received between the AP 104 and the STAs 106A-106D in accordance with multi-user (MU) modes in which multiple devices are permitted to transmit at the same time. For example, the AP 104 and the STAs 106A-106D can communicate using OFDM/OFDMA or multi-user multiple input multiple output (MU-MIMO) techniques. If this is the case, the wireless communication system 100 can be referred to as a MU, OFDM/OFDMA, or a MU-MIMO system. In various aspects, MU transmissions by STAs 106A-106D are scheduled by the AP 104, for example by a trigger frame. Here, MU mode generally refers to scheduled-based transmissions. In an extreme case, only one STA can be scheduled by the AP.

As discussed above, according to CSMA, devices sense the medium and only transmit when the medium is sensed to be idle. Thus, if the AP104 and/or STAs 106A-106D are operating according to the CSMA mechanism and a device in the BSA 102 (for example, the AP 104) is transmitting data, then in some aspects APs and/or STAs outside of the BSA 102 may not transmit over the medium even though they are part of a different BSA.

In such circumstances, the use of the CSMA mechanism can creates inefficiencies because some APs or STAs outside of a BSA can be able to transmit data without interfering with a transmission made by an AP or STA in the BSA. As the number of active wireless devices continues to grow, the inefficiencies can begin to significantly affect network latency and throughput. For example, significant network latency issues may appear in apartment buildings, in which each apartment unit may include an access point and associated stations. In fact, each apartment unit may include multiple access points, as a resident may own a wireless router, a video game console with wireless media center capabilities, a television with wireless media center capabilities, a cell phone that can act like a personal hot-spot, and/or the like.

Accordingly, there are various circumstances in which SU communication mode can be undesirable. For example, for STAs with at the edge of a BSA, MU-only communication may be the only way to close the link. As another example, for STAs with heavy UL traffic, MU-only communication may advantageously reduce the impact of contention and/or collisions.

On the other hand, there are various circumstances in which MU communication mode can be undesirable. For example, for STAs with sporadic delay-sensitive UL traffic such as sensor reports, SU-only communication can advantageously reduce scheduling latency inherent in MU communication. Accordingly, there is a need for signaling and processing to allow the AP 104 and/or STAs 106A-106D to selectively intercommunicate according to one of three communication states: a first state in which both SU and MU communications are permitted with respect to the AP 104 (“mixed-mode communications”), a second state in which only SU communications are permitted with respect to the AP 104 (“SU-only communications”), and a third state in which only MU communications are permitted with respect to the AP 104 (“MU-only communications”).

### SU-Only Communications

In various aspects, any of the STAs 106A-106D can be configured to communicate with the AP 104 via SU-only communications in which STAs 106A-106D traffic is sent only by CSMA. Accordingly, the AP 104 can be configured to communicate with any of the STAs 106A-106D only via CSMA, although the AP 104 can remain configured to communicate with remaining STAs according to MU techniques. For STAs to which the AP 104 is configured to communicate via SU-only communications, the AP 104 can exclude the STA in any MU transmissions. For example, the AP 104 can be configured to exclude the STA in scheduling messages such as trigger frames, to exclude the STA from polling mechanisms (for example, for scheduling information feedback), and so on.

### MU-Only Communications

In various aspects, any of the STAs 106A-106D can be configured to communicate with the AP 104 via MU-only communications in which STAs 106A-106D traffic is sent only according to MU transmission schemes such as MU-MIMO, OFDMA, OFDMA with random access, and so on. Accordingly, the AP 104 can be configured to communicate with any of the STAs 106A-106D only via MU communications, although the AP 104 can remain configured to communicate with remaining STAs according to SU techniques. For STAs configured to communicate via MU-only communications, such STAs can refrain from transmitting via CSMA techniques. For STAs to which the AP 104 is configured to communicate via MU-only communications, the AP 104 can ensure that the STA is scheduled for transmission or reception on a regular basis.

### Mixed-Mode Communications

In various aspects, any of the STAs 106A-106D can be configured to communicate with the AP 104 via both SU and MU modes. Accordingly, the AP 104 can be configured to communicate with any of the STAs 106A-106D via either SU or MU communications, although the AP 104 can remain configured to communicate with remaining STAs according to SU-only or MU-only modes. For STAs configured to communicate via mixed-mode communications, such STAs can select either SU or MU modes for transmission, and can be ready to receive AP 104 transmissions via both SU and MU modes. For STAs to which the AP 104 is configured to communicate via mixed-mode communications, the AP 104 can select either SU or MU modes for transmission to that STA, and can be ready to receive STA transmissions via both SU and MU modes.

### Implementing Devices

FIG. 2 illustrates various components that may be utilized in a wireless device 202 that may be employed within the wireless communication system 100 of FIG. 1. The wireless device 202 is an example of a device that may be configured to implement various aspects described herein. For example, the wireless device 202 may comprise the AP 104 or any one of the STAs 106A-106D.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include non-transitory machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas, which may be utilized during MIMO communications, for example.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. The DSP 220 may be configured to generate a data unit for transmission. In some aspects, the data unit may comprise a physical layer convergence procedure (PLCP) protocol data unit (PPDU). In some aspects, the PPDU is referred to as a packet.

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

The wireless device 202 may further comprise a high-efficiency wireless (HEW) component 250 in some aspects. The HEW component 250 may comprise the AP HEWC 154 and/or the STA HEWC 156. As described herein, the HEW component 250 may enable APs and/or STAs to transmit, receive, and/or process mode configuration requests discussed herein. For example, HEW component 250 can enable the wireless device 202 to set communication with another device in one of mixed-mode communications, SU-only communications, and MU-only communications.

The various components of the wireless device 202 may be coupled together by a bus system 226. The bus system 226 may include a data bus, for example, as well as a power bus, a control signal bus, and a status signal bus in addition to the data bus. Those of skill in the art will appreciate the components of the wireless device 202 may be coupled together or accept or provide inputs to each other using some other mechanism.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

### Mode Configuration Signaling

In various aspects, any of the AP 104 and the STAs 106A-106D can request configuration of communication (for a particular device pair) to one of mixed-mode communications, SU-only communications, and MU-only communications. In one aspect, the AP 104 can initiate a configuration request exchange with a STA to set communication between the AP 104 and that particular STA in one of mixed-mode communications, SU-only communications, and MU-only communications. In another aspect, any of the STAs 106A-106 can initiate a message exchange with the AP 104 to set communication between the AP 104 and that particular STA in one of mixed-mode communications, SU-only communications, and MU-only communications. In various aspects, exchanging communications can refer to transmitting a first communication then receiving a second communication, or receiving the first communication then transmitting a second communication. In some aspects, exchanging can be referred to as communicating.

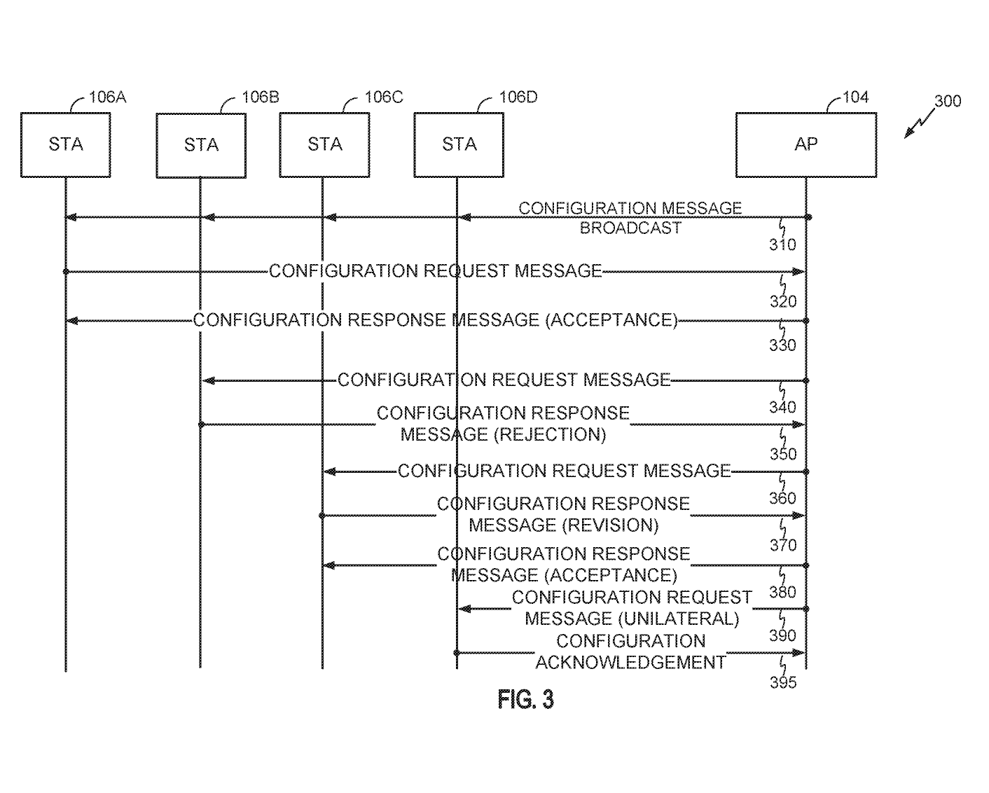

FIG. 3 illustrates an example configuration sequence 300 in wireless communication system 100 of FIG. 1. As shown in FIG. 3, the AP 104 and the STAs 106A-106D variously initiate and respond to configuration signaling according to various aspects.

### Mode Configuration Signaling—AP Broadcast

In one aspect, the AP 104 can initiate a configuration request broadcast to set communication between the AP 104 and a specified STA (or set of STAs) in one of mixed-mode communications, SU-only communications, and MU-only communications. For example, the AP 104 can broadcast or multicast SU/MU mode configuration, on a per STA basis, in one or more beacons. In configuration request broadcast aspects, the specified STA(s) are expected to obey the configuration request broadcast (with or without acknowledgment). As shown in FIG. 3, the AP 104 broadcasts a configuration request broadcast 310 to the STAs 106A-106D.

### Mode Configuration Signaling—Message Exchange

In one aspect, the configuration request exchange can be a negotiation based on which requesting device (for example, the AP 104 or STA 106A) sends a configuration request message to the responding device (for example, the STA 106A or AP 104), and the responding device sends a configuration response message to the requesting device. The configuration request message can indicate, for example, a request to set communications between the requesting device and the responding device to one of mixed-mode communications, SU-only communications, and MU-only communications. The configuration response message can indicate, for example, approval, rejection, or revision of the request. Revision can include, for example, a modified configuration response message different from the original configuration response message. In aspects where the responding device responds with a revision, the requesting device can treat the revision as a new configuration request message, and one or more additional rounds of request/response can be completed until the approval or rejection occurs.

In the illustrated acceptance aspect, for example, the STA 106A transmits a configuration request message 320 to the AP 104. The AP 104 responds with a configuration response message 330 indicating acceptance. In the illustrated rejection aspect, the AP 104 transmits a configuration request message 340 to the STA 106B. The STA 106B transmits a configuration response message 350 to the AP 104 indicating rejection. In the illustrated revision aspect, the AP 104 transmits a configuration request message 360 to the STA 106D. The STA 106D responds with a configuration response message 370 indicating revised configuration parameters. The AP 104 responds with a configuration response message 380 indicating acceptance (although the AP 104 could also reject or propose new revisions).

In another aspect, the configuration request exchange can be non-negotiation based or unilateral. For example, the requesting device (for example, the AP 104 or the STA 106A) can send a configuration request message to the responding device (for example, the STA 106A or the AP 104), and the responding device can simply send an acknowledgement that the configuration request message was received. In cases where the configuration request message is not received, the responding device can send no reply or a negative acknowledgement. In unilateral configuration message exchange aspects, the responding device is expected to obey the configuration request message. In another example, the requesting device (for example, the AP 104) can send a trigger frame to the responding device (for example, the STA 106A). The trigger frame can include scheduling information for the responding device and/or other devices. A rule can be made such that the responding device will enter the mixed-mode or MU-only states after receiving a trigger frame. Another rule can be made such that the responding device will enter the SU-only mode if not receiving a trigger frame for a certain time duration. In addition, separate enhanced distributed channel access (EDCA) parameter sets can be assigned for CSMA based transmissions in the SU-only and mixed-mode communications, respectively. The responding device should use the EDCA parameter set for the SU-only or mixed-mode communications after entering the corresponding mode.

In the illustrated unilateral aspect, for example, the AP 104 transmits a configuration request message 390 to the STA 106D. The STA 106D obeys the configuration request message 390 and responds with a configuration acknowledgement 395. In other aspects, the configuration acknowledgment 395 can be omitted.

### Incentive Rule

In aspects where the STA 106A initiates the configuration request, the AP 104 can apply one or more incentive rules to encourage or discourage the STA 106A from selecting certain modes. For example, BSS efficiency can be increased when more STAs select MU-only communications. Accordingly, the AP 104 can favor MU-only STAs during MU scheduling (for example, by satisfying their quality-of-service requirements first, allocating at least a minimum percentage of resources per scheduling message, and so on). In various aspects, the AP 104 can broadcast an indication of such incentives, for example in beacons. Thus, in one example, the AP 104 can transmit an indication that it will allocate at least a certain percentage of resources for MU-only STAs. In the illustrated aspect, the configuration request broadcast 310 can include the incentive indication.

### Configuration Request Formatting

In various aspects, the configuration request (which can include any of the configuration request message, the configuration response message with revision, the configuration request broadcast, and so on) can be included in one or more control fields, information elements, and/or physical layer (PHY) headers.

In various aspects, the configuration request can be carried in an “SU/MU mode configuration” HE control field. The HE control field can be carried in a HE control frame or piggybacked in a MAC header of other frames, such as HE data frames. Thus, in various aspects, the configuration request can be transmitted in a previously undefined HE control field.

In various aspects, the configuration request can be added to an existing receiver operation mode indicator (ROMI). In some aspects, the ROMI indicates a number of spatial steams for receiver (RX) operation, and channel bandwidth (BW) to be configured. In one aspect, the ROMI can indicate the configuration request. In some aspects, the ROMI can be carried in an HE control field.

In various aspects, the configuration request can be carried in a modified QoS control field. For example, in some aspects, the QoS control field can be in a MAC header of a QoS data frame or QoS null frame. In an aspect, bit 4 (the fourth bit) of the QoS control field can indicate whether bits 8-25 indicate a TXOP duration requested or a queue size. In another aspect, bit 4 of the QoS control field can indicate the communication mode that the transmitting device is requesting (for example, 0b0 for mixed-mode communications, and 0b1 for MU-only mode communications). In an aspect, one mode (for example, SU-only mode) can be a default mode.

In various aspects, the configuration request can be carried in a control frame. For example, the configuration request can be carried in a trigger frame, a ready-to-send (RTS) frame, a clear-to-send (CTS) frame, and so on. Thus, the configuration request can be carried in a previously undefined field of a control frame.

In various aspects, the configuration request can be carried in an IE of a management and/or action frame. For example, the configuration request can be carried in an IE of a beacon. Thus, the configuration request can be carried in a previously undefined IE.

In various aspects, the configuration request can be carried in a PHY header. For example, the configuration request can be carried in a SIG-A field of an 802.11ax PHY header. Thus, the configuration request can be carried in a previously undefined field of a PHY header.

### Contents of the Mode Configuration Request

In various aspects, the configuration request (which can include any of the configuration request message, the configuration response message with revision, the configuration request broadcast, and so on) can indicate that communication between the requesting device (or device transmitting the configuration request) and the responding device (or the device receiving the configuration request) should proceed in one of mixed-mode communications, SU-only communications, and MU-only communications. For example, the configuration request can include a single bit indicating the desired communication mode, such as 0b0 for mixed-mode communications and 0b1 for MU-only communications.

In various aspects, the configuration request can indicate one or more data traffic types to which the selected communication mode applies. In some aspects, non-indicated data traffic types can be communicated according to any communication mode, or a default communication mode (such as, for example, SU mode). Data traffic types can be identified, for example, by traffic identifiers, access categories, traffic classes, and the like. As an example, the AP 104 can transmit a configuration request message to the STA 106A indicating that MU-only communications should be used for background traffic, and that mixed-mode communications should be used for voice and video traffic.

In various aspects, the configuration request can indicate one or more frame types and/or frame subtypes to which the selected communication mode applies. In some aspects, non-indicated frame types and/or frame subtypes can be communicated according to any communication mode, or a default communication mode (such as, for example, SU mode). As an example, the STA 106A can transmit a configuration request message to the AP 104 indicating that MU-only communications should be used for data frames, and that mixed-mode communications should be used for control and management frames.

In various aspects, the configuration request can indicate one or more STAs to which the selected communication mode applies. In some aspects, non-indicated STAs can communicate according to any communication mode, or a default communication mode (such as, for example, SU mode). As an example, the AP 104 can broadcast a configuration request to the STAs 106A-106D indicating that MU-only communications should be used for STAs 106A-106B, and that mixed-mode communications should be used STAs 106C-106D. In various aspects, the AP 104 can identify STAs using an identifier such as media access control (MAC) address, or by classification such as “associated STAs,” “non-associated STAs,” and so on.

In various aspects, the configuration request can indicate one or more information (info) types to which the selected communication mode applies. In some aspects, non-indicated info types can be communicated according to any communication mode, or a default communication mode (such as, for example, SU mode). As an example, the AP 104 can transmit a configuration request message to the STA 106A indicating that SU-only communications should be used for feedback of sounding, and that mixed-mode communications should be used for buffer status, channel quality indication (CQI), and data.

In various aspects, the configuration request can indicate one or more link types (for example, UL, DL, or both) to which the selected communication mode applies. In some aspects, non-indicated link types can be communicated according to any communication mode, or a default communication mode (such as, for example, SU mode). As an example, the STA 106A can transmit a configuration request message to the AP 104 indicating that MU-only communications should be used for UL, and that mixed-mode communications should be used for DL.

In various aspects, the configuration request can indicate one or more communication resources to which the selected communication mode applies. In some aspects, non-indicated communication resources can be communicated according to any communication mode, or a default communication mode (such as, for example, SU mode). As an example, the configuration request can indicate that the selected communication mode is valid only during a scheduled time window or a specific bandwidth. As another example, configuration request can be carried in a trigger frame, and can indicate that the selected communication mode is valid only in a granted transmit opportunity (TXOP). As another example, configuration request can be carried in a negotiation message, and can indicate that the selected communication mode is valid only in a negotiated service period.

In various aspects, the configuration request can indicate specific MU communication types allowed in MU-only or mixed-mode communications. For example, the configuration request can indicate that any combination of OFDMA and/or MU-MIMO is allowed in MU-only communications. As another example, the configuration request can indicate that only OFDMA is allowed in mixed-mode communications.

Although various conditions to which selected modes in configuration requests can apply are described independently herein, each condition can be cumulative or combined with other conditions. For example, a configuration request can indicate that MU-only communications should be used for background traffic, and can further indicate that the foregoing condition only applies to associated STAs. Similarly, a configuration request can indicate that mixed-mode communications should be used for DL communications of management frames, on a specified bandwidth.

In aspects where the configuration request is initiated by the AP 104, the configuration request can further configure SU and/or MU modes for peer-to-peer (P2P) communications. For example, the configuration request can specify allowed communication mode(s), corresponding conditions, and allowed MU types for all or a set of P2P nodes in the AP 104's coverage area.

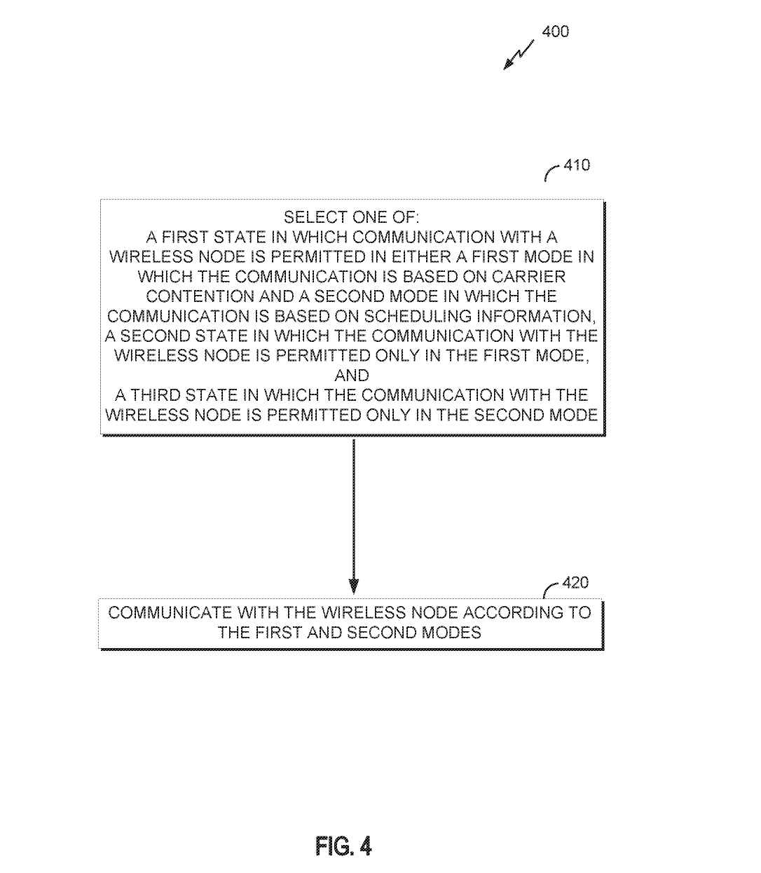

FIG. 4 is a flowchart 400 of an exemplary method of communicating in a wireless communication system. For example, the method of the flowchart 400 can be implemented within the wireless communication system 100 of FIG. 1, and with respect to the configuration sequence 300 of FIG. 3. Particularly, the method of the flowchart 400 can be implemented by one or more of the AP 104 and the STAs 106A-106D, or the wireless device 200 of FIG. 2. Although the method of the flowchart 400 is described herein with particular reference to the wireless communication system 100 of FIG. 1, the wireless device 202 of FIG. 2, and the configuration sequence 300 of FIG. 3, a person having ordinary skill in the art will appreciate that the method of flowchart 400 can be implemented with any other suitable device or format. In an aspect, the steps in the flowchart 400 can be performed by a processor or controller, such as the processor 204 or the DSP 220 in conjunction with one or more of the memory 206, the transmitter 210, and the receiver 212, described above with respect to FIG. 2. Although the method of the flowchart 400 is described herein with reference to a particular order, in various aspects, blocks herein can be performed in a different order, or omitted, and additional blocks can be added.

First, at block 410, the wireless device 202 selects one of a first state, a second state, and a third state. For example, when the wireless device 202 is configured as the AP 104, it can select a state to enter based on a request received from a STA 106A. As another example, the AP 104 can select a state to enter based on one or more metrics discussed herein (such as link quality with the STA 106A), and can generate a request for transmission to the STA 106A. The request (for example the configuration request message 320 or the configuration request message 360 configured for revision) can instruct the STA 106A to enter the selected state with respect to communication with the AP 104.

As another example, when the wireless device 202 is configured as the STA 106A, it can select a state to enter based on a request received from a AP 104. As another example, the STA 106A can select a state to enter based on one or more metrics discussed herein (such as link quality with the AP 104), and can generate a request for transmission to the AP 104. The request (for example the configuration broadcast message 310 or the configuration request message 340) can instruct the AP 104 to enter the selected state with respect to communication with the STA 106A.

In the first state, communication with a wireless node (such as the AP 104 or the STA 106A) is permitted in either a first mode in which the communication is based on a carrier contention or a second mode in which the communication is based on scheduling information. For example, in the first state, the wireless device 202 can communicate with the AP 104 or the STA 106A via mixed-mode communications described herein.

In the second state, communication with the other wireless device is permitted only in the first mode. For example, in the second state, the wireless device 202 can communicate with the AP 104 or the STA 106A via SU-only communications described herein. In the third state, communication with the other wireless device is permitted only in the second mode. For example, in the third state, the wireless device 202 can communicate with the AP 104 or the STA 106A via MU-only communications described herein.

In various aspects, the method can further include receiving the scheduling information in a trigger frame prior to the communication. For example, the AP 104 can transmit a trigger frame scheduling MU communications with respect to STAs 106A-106D, which can be received by at least the STA 106A. In various embodiments, the apparatus executing the method can be the AP 104 or the STA 106A.

Then, at block 420, the wireless device 202 communicates with the wireless node according to the first and second modes. In an aspect, the wireless device 202 communicates with the wireless node according to modes allowed in the selected state.

In various aspects, the processing system can be further configured to select the first, second, or third state by processing a request to enter the first, the second, or third state based on one or more metrics. For example, the wireless device 202 can be configured as the STA 106A, and can process (for example, by generating or transmitting) a configuration request message 320 for transmission to the AP 104. In another example, the wireless device 202 can be configured as the AP 104, and can process (for example, by receiving or decoding) the configuration request message 320 received from the STA 106A. In other aspects, the AP 104 can process (for example, by generating or transmitting) the configuration request message 340 for transmission to the STA 106B, which can receive and then process (for example, by decoding) the configuration request message 340.

In various aspects, the one or more metrics can include any combination of: a link budget, a signal strength received from the wireless device, a contention or collision metric, and a packet latency requirement. In various aspects, the request can be carried in any combination of: a mode configuration high-efficiency (HE) control field, a receiver operation mode indicator (ROMI) HE control field, a quality-of-service (QoS) control field, a control frame, a management frame, an action frame, a beacon, or a physical layer (PHY) header.

In various aspects, the processing system can be further configured to generate a configuration request requesting entry into any of the first, second, or third state and a configuration response approving, rejecting, or revising the configuration request. For example, the wireless device 202 can be configured as the STA 106A, and can process a configuration request message 320 for transmission to the AP 104, which can respond with the configuration response message 330. In another example, the wireless device 202 can be configured as the AP 104, and can process the configuration request message 320 received from the STA 106A and can process the configuration response message 330 for transmission to the STA 106A. In other aspects, the AP 104 can process the configuration request message 340 for transmission to the STA 106B, which can receive and then process the configuration request message 340, and subsequently respond with the configuration response message 350.

In various aspects, the configuration request can be carried in any combination of: a mode configuration high-efficiency (HE) control field, a receiver operation mode indicator (ROMI) HE control field, a quality-of-service (QoS) control field, a control frame, a management frame, an action frame, a beacon, or a physical layer (PHY) header.

In various aspects, the configuration request can indicate that the first, second, or third state applies only to communications meeting one or more conditions specified in the configuration request. In various aspects, the one or more conditions specified in the configuration request can include any combination of: certain data traffic types, certain frame types or subtypes, certain stations or station types, certain information types, uplink (UL) communications, downlink (DL) communications, both UL and DL communications, certain communications resources including scheduled time windows, bandwidths, transmit opportunities (TXOPs), or service periods.

In various aspects, the configuration request can specify one or more allowed multi-user (MU) communication types if the third state is selected. In various aspects, the configuration request can specify one or more selected modes, one or more corresponding conditions, and one or more allowed multi-user (MU) communication types.

In various aspects, the processing system can be further configured to communicate, with the wireless device, a unilateral configuration message announcing entry into any of the first, second, or third state, and an acknowledgment message acknowledging receipt of the unilateral configuration message. For example, the wireless device 202 can be configured as the AP 104, and can process a configuration request message 390 for transmission to the STA 106D, which can respond with the configuration acknowledgment 395. In another example, the wireless device 202 can be configured as the STA 106D, and can process the configuration request message 390 received from the AP 104 and can process the configuration acknowledgment 395 for transmission to the AP 104. In other aspects, a STA can process the configuration request message for transmission to the AP, which can receive and then process the configuration request message, and subsequently respond with the configuration acknowledgment.

In various aspects, the processing system can be further configured to exclude the wireless node in any communications under the second mode, wherein the communication is in the first mode. For example, when the AP 104 is configured for SU-only communication with the STA 106A, the AP 104 can exclude the STA 106A from scheduling messages.

In various aspects, the processing system can be further configured to schedule any combination of more resources, communications priority, or acceptance of requests, for wireless nodes that select the third state for reciprocal communication with the apparatus. For example, the AP 104 can schedule MU-only stations first, or allocate a minimum percent of resources to MU-only stations. In general, “scheduling” a station can include any of: providing more resources, communications priority, and/or acceptance of requests. In various aspects, the processing system can be further configured to generate a message, for transmission by the communication interface, advertising a degree to which the apparatus favors the wireless nodes that select the third state for reciprocal communication with the apparatus. For example, the AP 104 can transmit an indication of incentive rules in a beacon.

In some aspects, the processing system can be further configured to generate, for transmission by the communication interface, a trigger frame instructing the wireless node to enter the first state. For example, the AP 104 can transmit a trigger frame to the STA 106A. In some aspects, the trigger frame includes scheduling information for the wireless communication. For example, the trigger frame can schedule MU communications for the STA 106A. After the scheduled communications, the STA 106A can enter the SU-only communications mode.

In some aspects, the method shown in FIG. 4 can be implemented in a wireless device that can include a selecting circuit and a communicating circuit. Those skilled in the art will appreciate that a wireless device can have more components than the simplified wireless device described herein. The wireless device described herein includes components useful for describing some features of implementations.

The selecting circuit can be configured to select the communication mode. In some aspects, the selecting circuit can be configured to perform at least block 410 of FIG. 4. The selecting circuit can include a processing system which can include one or more of the processor 204 (FIG. 2), the memory 206 (FIG. 2), and the DSP 220 (FIG. 2). In some implementations, means for selecting can include the selecting circuit.

The communicating circuit can be configured to communicate with the wireless node according to the first and second modes. In some aspects, the communicating circuit can be configured to perform at least block 420 of FIG. 4. The communicating circuit can include a processing system which can include one or more of the processor 204 (FIG. 2), the memory 206 (FIG. 2), and the DSP 220 (FIG. 2), the transmitter 210 (FIG. 2), the receiver 212 (FIG. 2), the antenna 216 (FIG. 2), and the transceiver 214 (FIG. 2). In some communicating, means for communicating can include the communicating circuit.

In some aspects, the apparatus can further include a processing circuit. The processing circuit can be configured to select one of the first, second, or third state based on one or more metrics. The processing circuit can include a processing system which can include one or more of the processor 204 (FIG. 2), the memory 206 (FIG. 2), and the DSP 220 (FIG. 2). In some implementations, means for processing can include the processing circuit.

In some aspects, the apparatus can further include a scheduling circuit. The scheduling circuit can be configured to schedule any combination of more resources, communications priority, or acceptance of requests, to wireless nodes that select the third state for reciprocal communication with the apparatus. The scheduling circuit can include a processing system which can include one or more of the processor 204 (FIG. 2), the memory 206 (FIG. 2), and the DSP 220 (FIG. 2). In some implementations, means for scheduling can include the scheduling circuit.

In some aspects, the apparatus can further include a generating circuit. The generating circuit can be configured to generate any of the messages discussed herein. The generating circuit can include a processing system which can include one or more of the processor 204 (FIG. 2), the memory 206 (FIG. 2), and the DSP 220 (FIG. 2). In some implementations, means for generating can include the generating circuit.

In some aspects, the apparatus can further include an exchanging circuit. The exchanging circuit can be configured to exchange any of the messages discussed herein with the wireless node. The exchanging circuit can include a processing system which can include one or more of the transmitter 210 (FIG. 2), the receiver 212 (FIG. 2), the antenna 216 (FIG. 2), and the transceiver 214 (FIG. 2). In some implementations, means for exchanging can include the exchanging circuit.

In some aspects, the apparatus can further include a sending circuit. The sending circuit can be configured to transmit any of the messages discussed herein with the wireless node. The sending circuit can include a processing system which can include one or more of the transmitter 210 (FIG. 2), the antenna 216 (FIG. 2), and the transceiver 214 (FIG. 2). In some implementations, means for sending can include the sending circuit.

In some aspects, the apparatus can further include an outputting circuit. The outputting circuit can be configured to output for transmission any of the messages discussed herein with the wireless node. The outputting circuit can include a processing system which can include one or more of the processor 204 (FIG. 2), the memory 206 (FIG. 2), and the DSP 220 (FIG. 2, the transmitter 210 (FIG. 2), the antenna 216 (FIG. 2), and the transceiver 214 (FIG. 2). In some implementations, means for outputting can include the outputting circuit.

In some aspects, the apparatus can further include an advertising circuit. The advertising circuit can be configured to generate a message, for transmission by the communication interface, advertising a degree to which the apparatus favors the wireless nodes that select the third state for reciprocal communication with the apparatus. The advertising circuit can include a processing system which can include one or more of the transmitter 210 (FIG. 2), the antenna 216 (FIG. 2), and the transceiver 214 (FIG. 2). In some implementations, means for advertising can include the advertising circuit.

In some aspects, the apparatus can further include an excluding circuit. The excluding circuit can be configured to exclude a selected the wireless node in any transmissions under the second mode, wherein the communication is in the first mode. The excluding circuit can include a processing system which can include one or more of the processor 204 (FIG. 2), the memory 206 (FIG. 2), the DSP 220 (FIG. 2), the transmitter 210 (FIG. 2), the antenna 216 (FIG. 2), and the transceiver 214 (FIG. 2). In some implementations, means for excluding can include the excluding circuit.

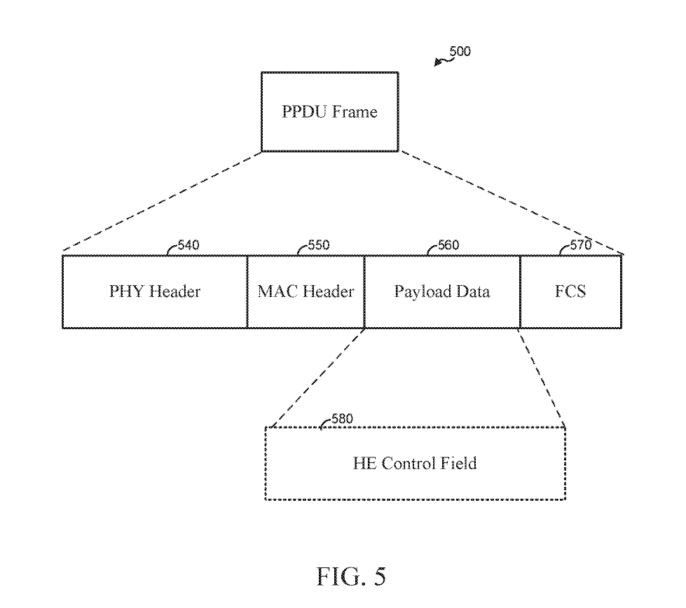

FIG. 5 is a diagram illustrating an exemplary embodiment of a frame 500 including a configuration request. In various embodiments, the frame 500 can be include one or more of a PPDU, a control frame, a management frame, an action frame, or a beacon. As shown in FIG. 5, the frame 500 comprises a physical layer (PHY) header 540, a MAC header field 550, a payload data portion 560, and a frame check sequence (FCS) field 570. The PHY header 540 may be used to acquire an incoming OFDM signal, to train and synchronize a demodulator, and may aid in demodulation and delivery of the payload data portion 560.

In some embodiments, the payload data portion 560 can include an HE control field 580. The HE control field 580 can be designated as one or more of a mode configuration control field, a receiver operation mode indicator (ROMI) control field, a quality-of-service (QoS) control field, etc.

In various embodiments, the configuration request can be included in any combination of the HE control field 580 (e.g., mode configuration, ROMI, or QOS control field), the PHY header 540, or elsewhere in the frame 500 configured as a PPDU, control frame, management frame, action frame, beacon, or other frame.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

As used herein, the term “determining” encompasses a wide variety of actions. For example, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like. Further, a “channel width” as used herein can encompass or can also be referred to as a bandwidth in certain aspects.

As used herein, a phrase referring to “any combination of” a list of items refers to any combination of those items, including single members. As a first example, “any combination of a and b” (also “a or b”) is intended to cover a, b, and a-b, as well as any combination with multiples of the same element (e.g., a-a, a-a-a, a-a-b, a-b-b, b-b, b-b-b, or any other ordering of a and b). As a second example, “any combination of: a, b, and c” (also “a, b, or c”) is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various operations of methods described above can be performed by any suitable means capable of performing the operations, such as various hardware and/or software component(s), circuits, and/or module(s). Generally, any operations illustrated in the Figures can be performed by corresponding functional means capable of performing the operations.

The various illustrative logical blocks, modules and circuits described in connection with the present disclosure can be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor can be a microprocessor, but in the alternative, the processor can be any commercially available processor, controller, microcontroller or state machine. A processor can also be implemented as a combination of computing devices, e.g., a combination of a DSP and a microprocessor, a plurality of microprocessors, one or more microprocessors in conjunction with a DSP core, or any other such configuration.

In one or more aspects, the functions described can be implemented in hardware, software, firmware, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium can include transitory and/or non-transitory computer readable medium (e.g., tangible media). In addition, in some aspects computer readable medium can include transitory computer readable medium (e.g., a signal). Combinations of the above should also be included within the scope of computer-readable media.

The methods disclosed herein include one or more steps or actions for achieving the described method. The method steps and/or actions can be interchanged with one another without departing from the scope of the claims. In other words, unless a specific order of steps or actions is specified, the order and/or use of specific steps and/or actions can be modified without departing from the scope of the claims.

The functions described can be implemented in hardware, software, firmware or any combination thereof. If implemented in software, the functions can be stored as one or more instructions on a computer-readable medium. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects can include a computer program product for performing the operations presented herein. For example, such a computer program product can include a computer readable medium having instructions stored (and/or encoded) thereon, the instructions being executable by one or more processors to perform the operations described herein. For certain aspects, the computer program product can include packaging material.

Software or instructions can also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations can be made in the arrangement, operation and details of the methods and apparatus described above without departing from the scope of the claims.

While the foregoing is directed to aspects of the present disclosure, other and further aspects of the disclosure can be devised without departing from the basic scope thereof, and the scope thereof is determined by the claims that follow.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

1. An apparatus configured for wireless communication, comprising:
a processing system configured to select one of:
a first state in which communication with a wireless node is permitted in either a first mode in which the communication is based on a carrier contention or a second mode in which the communication is based on scheduling information;
a second state in which the communication with the wireless node is permitted only in the first mode; and
a third state in which the communication with the wireless node is permitted only in the second mode; and
a communication interface configured to communicate with the wireless node according to the first and second modes.

2. The apparatus of claim 1, wherein the processing system is further configured to receive the scheduling information in a trigger frame prior to the communication.

3. The apparatus of claim 1, wherein the processing system is further configured to select one of the first, second, or third state based on one or more metrics.

4. The apparatus of claim 3, wherein the one or more metrics comprise any combination of: a link budget, a signal strength received from the wireless node, a contention or collision metric, and a packet latency requirement.

5. The apparatus of claim 3, wherein the processing system is further configured to receive a request to select one of the first, second, or third state, wherein the request is carried in any combination of: a mode configuration high-efficiency (HE) control field, a receiver operation mode indicator (ROMI) HE control field, a quality-of-service (QoS) control field, a control frame, a management frame, an action frame, a beacon, or a physical layer (PHY) header.

6. The apparatus of claim 1, wherein:
the processing system is further configured to generate a configuration request requesting entry into any of the first, second, or third state; and
the communication interface is further configured to provide the configuration request for transmission to the wireless node.

7. The apparatus of claim 6, wherein the configuration request is carried in any delete combination of: a mode configuration high-efficiency (HE) control field, a receiver operation mode indicator (ROMI) HE control field, a quality-of-service (QoS) control field, a control frame, a management frame, an action frame, a beacon, or a physical layer (PHY) header.

8. The apparatus of claim 6, wherein the configuration request indicates that the first, second, or third state applies only to communications meeting one or more conditions specified in the configuration request.

9. The apparatus of claim 8, wherein the one or more conditions specified in the configuration request comprise any combination of: certain data traffic types, certain frame types or subtypes, certain stations or station types, certain information types, uplink (UL) communications, downlink (DL) communications, both UL and DL communications, certain communications resources including scheduled time windows, bandwidths, transmit opportunities (TXOPs), or service periods.

10. The apparatus of claim 6, wherein the configuration request specifies one or more allowed multi-user (MU) communication types if the third state is selected.

11. The apparatus of claim 6, wherein the configuration request specifies one or more selected modes, one or more corresponding conditions, and one or more allowed multi-user (MU) communication types.

12. The apparatus of claim 6, wherein the communication interface is further configured to receive, from the wireless node, a configuration response comprising a revised configuration, wherein the processing system is further configured to generate a second configuration response comprising information approving, rejecting, or revising the revised configuration, wherein the communication interface is further configured to output for transmission, to the wireless node, the second configuration response.

13. The apparatus of claim 1, wherein the processing system is further configured to generate a unilateral configuration message announcing entry into any of the first, second, or third state, wherein the communication interface is further configured to output the unilateral configuration message for transmission to the wireless node.

14. The apparatus of claim 1, wherein the processing system is further configured to generate a trigger frame instructing the wireless node to enter the first state, and the communication interface is configured to output the trigger frame for transmission to the wireless node.

15. The apparatus of claim 14, wherein the trigger frame includes scheduling information for the wireless communication.

16. The apparatus of claim 1, wherein the processing system is further configured to exclude the wireless node in any communications under the second mode, wherein the communication is in the first mode.

17. The apparatus of claim 1, wherein the processing system is further configured to schedule any combination of more resources, communications priority, or acceptance of requests, for wireless nodes that select the third state for reciprocal communication with the apparatus, wherein the communication interface is further configured communicate with the wireless node based on the schedule.

18. The apparatus of claim 17, wherein the processing system is further configured to generate an advertisement message advertising a degree to which the apparatus favors the wireless nodes that select the third state for reciprocal communication with the apparatus, wherein the communication interface is further configured to output the message for transmission to the wireless node.

19. A method for wireless communication, comprising:
selecting, at an apparatus, one of:
a first state in which communication with a wireless node is permitted in either a first mode in which the communication is based on a carrier contention or a second mode in which the communication is based on scheduling information;
a second state in which the communication with the wireless node is permitted only in the first mode; and
a third state in which the communication with the wireless node is permitted only in the second mode; and
communicating with the wireless node according to the first and second modes.

20-55. (canceled)

56. A wireless node for wireless communication, comprising:
at least one antenna;
a processing system configured to select one of:
a first state in which communication with a second wireless node is permitted in either a first mode in which the communication is based on a carrier contention or a second mode in which the communication is based on scheduling information;
a second state in which the communication with the second wireless node is permitted only in the first mode; and
a third state in which the communication with the second wireless node is permitted only in the second mode;
a communication interface configured to communicate via the at least one antenna with the second wireless node according to the first and second modes.
